(19) United States
(12) Patent Application Publication
(10) Pub. No.: US 2024/0124320 A1
(43) Pub. Date: Apr. 18, 2024

(54) ANODE ACTIVE MATERIAL COMPRISING TRANSITION METAL OXIDE, ANODE USING SAME, AND PREPARATION METHOD FOR ANODE ACTIVE MATERIAL

(71) Applicant: INDUSTRY-UNIVERSITY COOPERATION FOUNDATION HANYANG UNIVERSITY ERICA CAMPUS, Ansan-si (KR)

(72) Inventors: Jin Ho Bang, Ansan-si (KR); Sang Eun Bak, Ansan-si (KR); Muhammad Awais Abbas, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 18/524,284

(22) Filed: Nov. 30, 2023

Related U.S. Application Data
(63) Continuation of application No. PCT/KR2022/007463, filed on May 26, 2022.

(30) Foreign Application Priority Data
Jun. 11, 2021 (KR) 10-2021-0075909

(51) Int. Cl. C01G 33/00; B01J 31/02

(52) U.S. Cl. CPC C01G 33/00; B01J 31/0209; C01P 2002/30; C01P 2004/62

(57) ABSTRACT

An anode active material comprising a transition metal oxide is provided. A method for preparing the anode active material may comprise the steps of preparing a first transition metal oxide source and a second transition metal oxide source; providing the first transition metal oxide source and the second transition metal oxide source for a secondary alcohol to prepare a base source; providing a hydrolysis catalyst for the base source and inducing a sol-gel reaction to prepare a transition metal oxide precursor; and subjecting the transition metal oxide precursor to heat treatment in a nitrogen environment to prepare an anode active material containing a transition metal oxide.

### CROSS REFERENCE TO RELATED APPLICATIONS

This is a continuation of International Patent Application PCT/KR2022/007463 (filed 26 May 2022), which claims the benefit of Republic of Korea Patent Application KR 10-2021-0075909 (filed 11 Jun. 2021). The entire disclosure of each of these priority applications is hereby incorporated by reference herein.

### BACKGROUND OF THE INVENTION

### 1. Field of the Invention

The present invention relates to an anode active material including a transition metal oxide, an anode electrode using the same, and a preparation method thereof, and more specifically, to an anode active material having a chemical composition of TiNbO₄ and including carbon and pores, an anode electrode using the same, and a preparation method thereof.

### 2. Description of the Prior Art

Small IT devices such as smart phones, etc., took the lead in the initial growth of a global secondary battery market, but recently, a secondary battery market for vehicles is rapidly growing with the growth of an electric vehicle market.

Secondary batteries for vehicles are leading the growth of the electric vehicle market while enabling mass production through product standardization and achieving low prices and stable performance through technology development, and the market is rapidly expanding as a short mileage, which was pointed out as a limitation of electric vehicles, has been resolved by improving battery performance.

For example, Korean Patent Registration Publication No. 10-1788232 discloses an electrode for a secondary battery in which an electrode mixture including an electrode active material and a binder is coated on a current collector, and in which the electrode includes: a first electrode mixture layer which contains an electrode active material and a first binder having a glass transition temperature (Tg) lower than that of a second binder and is coated on the current collector; and a second electrode mixture layer which contains an electrode active material and a second binder having a glass transition temperature (Tg) higher than that of the first binder and is coated on the first electrode mixture layer, in which a glass transition temperature (Tg) of the first binder is 15° C. or less; the glass transition temperature (Tg) of the second binder is 10° C. or more in a range higher than the glass transition temperature of the first binder; the glass transition temperature (Tg) of the second binder is 10° C. or more to less than 25° C. in a range higher than the glass transition temperature of the first binder; the electrode for the secondary battery is an anode; and the electrode active material includes a Si-based material.

### SUMMARY OF THE INVENTION

One technical object of the present invention is to provide an anode active material including a transition metal oxide capable of easy intercalation and deintercalation of lithium ions, an anode electrode using the same, and a preparation method thereof.

Another technical object of the present invention is to provide an anode active material including a transition metal oxide with improved electrical conductivity, an anode electrode using the same, and a preparation method thereof.

Still, another technical object of the present invention is to provide an anode active material including a transition metal oxide with improved high efficiency, high reliability, and stability in a charge/discharge cycle of a lithium secondary battery, an anode electrode using the same, and a preparation method thereof.

Still another technical object of the present invention is to provide an anode active material including a transition metal oxide with a negative fading property in a charge/discharge cycle of a lithium secondary battery, an anode electrode using the same, and a preparation method thereof.

Still, another technical object of the present invention is to provide an anode active material including a transition metal oxide with reduced manufacturing process costs, an anode electrode using the same, and a preparation method thereof.

Still, another technical object of the present invention is to provide an anode active material including a transition metal oxide with a shortened manufacturing time, an anode electrode using the same, and a preparation method thereof.

Still, another technical object of the present invention is to provide an anode active material including a transition metal oxide capable of easy mass production, an anode electrode using the same, and a preparation method thereof.

The technical objects of the present invention are not limited to the above.

To solve the above technical objects, the present invention may provide a method for preparing an anode active material including a transition metal oxide.

According to one embodiment, the method for preparing the anode active material may include: preparing a first transition metal oxide source and a second transition metal oxide source; providing the first transition metal oxide source and the second transition metal oxide source for a secondary alcohol to prepare a base source; providing a hydrolysis catalyst for the base source and inducing a sol-gel reaction to prepare a transition metal oxide precursor; and subjecting the transition metal oxide precursor to heat treatment in a nitrogen environment to prepare an anode active material containing a transition metal oxide.

According to one embodiment, the transition metal oxide precursor may be subjected to heat treatment at a temperature of more than 550° C.

According to one embodiment, surface roughness, crystallinity, carbon atom content, and pore size of particles of the anode active material being generated may be controlled by a temperature at which the transition metal oxide precursor is subjected to heat treatment.

According to one embodiment, the surface roughness of particles of the anode active material being generated may increase as the temperature for heat treatment of the transition metal oxide precursor increases; a grain size of the particles of the anode active material being generated may increase and thus crystallinity of the particles of the anode active material may increases, as the temperature for heat treatment of the transition metal oxide precursor increases; a carbon atom content of the particles of the anode active material being generated may decrease as the temperature for heat treatment of the transition metal oxide precursor increases; and a pore size of the particles of the anode active material being generated may increase as the temperature for heat treatment of the transition metal oxide precursor increases.

According to one embodiment, as the temperature for heat treatment of the transition metal oxide precursor increases, an oxygen vacancy in the particles of the anode active material may decrease due to a decrease in the carbon atom content of the particles of the anode active material being generated.

According to one embodiment, the hydrolysis catalyst may be acetone, in which distilled water may be further provided to the acetone and thus a sol-gel reaction of the base source may be induced by the distilled water.

According to one embodiment, the secondary alcohol may be any one of ethylene glycol, diethylene glycol, or triethylene glycol, in which the size of particles of the anode active material may be controlled to a nano-size by the secondary alcohol, and a carbon atom may be provided on a surface and an inside of the particles of the anode active material.

According to one embodiment, the first transition metal oxide source may be titanium butoxide, and the second transition metal oxide source may be niobium ethoxide.

To solve the above technical objects, the present invention may provide a method for preparing an anode electrode using the anode active material described above.

According to one embodiment, the method for preparing an anode electrode may include: preparing an anode active material according to the method for preparing the anode active material described above; stirring the anode active material and a polymer binder to prepare a slurry; and coating the slurry on a current collector to prepare an anode electrode.

To solve the above technical objects, the present invention may provide the anode active material described above.

According to one embodiment, the anode active material may include a nano-sized particle in which two transition metal atoms and an oxygen atom have tetragonal and rutile structures, in which a carbon atom may be provided on a surface and an inside of the particle and a pore may be provided in the particle.

According to one embodiment, the transition metal atoms may be Ti and Nb, and the chemical composition of the particle may be TiNbO₄.

According to one embodiment, the size of the particle may be 200 nm to 300 nm.

To solve the above technical objects, the present invention may provide the above-described anode active material and a lithium secondary battery in which the above-described anode electrode is inserted.

According to one embodiment, the lithium secondary battery may include the above-described anode electrode including the above-described anode active material, a cathode electrode disposed on the anode electrode and including lithium; and an electrolyte between the anode electrode and the cathode electrode, in which the battery may have a negative fading property in which a capacity of the battery increases as the number of charge/discharge cycles increases during charging/discharging.

According to an embodiment of the present invention, a method for preparing the anode active material may include: preparing a first transition metal oxide source and a second transition metal oxide source; providing the first transition metal oxide source and the second transition metal oxide source for a secondary alcohol to prepare a base source; providing a hydrolysis catalyst for the base source and inducing a sol-gel reaction to prepare a transition metal oxide precursor; and subjecting the transition metal oxide precursor to heat treatment in a nitrogen environment to prepare the anode active material containing a transition metal oxide.

The anode active material may include nano-sized particles. The particle may have tetragonal and rutile crystal structures which are formed of transition metal atoms Ti and Nb and oxygen atom O. In addition, the particle may include a carbon atom on a surface, an inside of the particle, and a pore inside the particle.

Thus, when performing a charge/discharge cycle by manufacturing a lithium secondary battery into which the anode active material is inserted, the intercalation and deintercalation of lithium ions may easily occur in the lithium secondary battery due to a crystal structure of the particle and a pore of the particle. In addition, the electrical conductivity of the lithium secondary battery may be improved by the carbon atoms on the surface and inside of the particle.

Accordingly, the lithium secondary battery may have high efficiency, high reliability, and stability in a charge/discharge cycle for a long period of time.

In addition, due to the nano size of the particle and the carbon atom in the anode active material, the lithium secondary battery may have a negative fading property in which the charge capacity of the lithium secondary battery is improved as the number of charge/discharge cycles increases.

### BRIEF DESCRIPTION OF THE DRAWINGS

FIG. 1 is a flowchart explaining a method for preparing an anode active material according to the first embodiment of the present invention.

FIG. 2 is a view for explaining a step of preparing a base source of a transition metal oxide precursor in the method for preparing an anode active material according to the first embodiment of the present invention.

FIGS. 3 to 4 are views for explaining a step of preparing a transition metal oxide precursor in the method for preparing an anode active material according to the first embodiment of the present invention.

FIG. 5 is a view for explaining the step of preparing an anode active material according to the first embodiment of the present invention.

FIG. 6 is a view for explaining an anode active material according to the first embodiment of the present invention.

FIG. 7 is a view showing a crystal structure of particles of anode active materials according to experimental examples of the present invention.

FIG. 8 is an XRD graph of transition metal oxide precursors and an SEM picture of anode active materials according to experimental examples of the present invention.

FIG. 9 is a graph analyzing through TGA equipment a heat treatment process for transition metal oxide precursors according to experimental examples of the present invention.

FIGS. 10 and 11 are graphs of analyzing through XRD anode active materials according to experimental examples of the present invention.

FIG. 12 is a view showing SEM pictures and TEM pictures of anode active materials according to Experimental Examples 1-5 to 1-8 of the present invention.

FIG. 13 is a graph of analyzing through Raman spectroscopy anode active materials according to Experimental Embodiments 1-5 to 1-8 of the present invention.

FIG. 14 is a graph of analyzing through electron paramagnetic resonance (EPR) anode active materials according to Experimental Embodiments 1-5 to 1-8 of the present invention.

FIG. 15 is a graph measuring a specific capacity value for each C-rate during charging/discharging of lithium secondary half-batteries according to Experimental Examples 1-3 to 1-8 of the present invention.

FIGS. 16A through 16F are graphs measuring a voltage change value according to a specific capacity for each C-rate of lithium secondary half-batteries according to Experimental Examples 1-3 to 1-8 of the present invention.

FIG. 17 is a graph of measuring stability for a charge/discharge cycle of lithium secondary half-batteries according to Experimental Examples 1-3 to 1-8 of the present invention.

FIG. 18 is a graph analyzing the chemical composition and crystal structure of anode active materials according to Experimental Embodiments 2-1 to 2-4 of the present invention.

FIG. 19 is a graph analyzing the surface area, pore size, and volume of anode active materials according to Experimental Embodiments 2-1 to 2-4 of the present invention.

FIG. 20 is a view showing SEM and TEM pictures of anode active materials according to Experimental Examples 2-1 to 2-4 of the present invention.

FIG. 21 is a graph measuring a specific capacity value for each C-rate during charging/discharging of lithium secondary half-batteries according to Experimental Examples 2-1 to 2-4 of the present invention.

FIGS. 22A through 22F are graphs measuring a voltage change value according to a specific capacity for each C-rate of lithium secondary half-batteries according to Experimental Examples 2-1 to 2-4 of the present invention.

FIG. 23 is a graph of measuring stability for a charge/discharge cycle of lithium secondary half-batteries according to Experimental Examples 2-1 to 2-4 of the present invention.

FIG. 24 is a graph measuring a coulombic efficiency (CE) value of lithium secondary half-batteries according to Experimental Examples 2-1 to 2-4 of the present invention.

### DETAILED DESCRIPTION OF THE EXEMPLARY EMBODIMENTS

Hereinafter, preferred embodiments of the present invention will be described in detail with reference to the accompanying drawings. However, the technical spirit of the present invention is not limited to the embodiments but may be realized in different forms. The embodiments introduced herein are provided to sufficiently deliver the spirit of the present invention to those skilled in the art so that the disclosed contents may become thorough and complete.

When it is mentioned in the specification that one element is on another element, it means that the first element may be directly formed on the second element or a third element may be interposed between the first element and the second element. Further, in the drawings, the thicknesses of the membrane and areas are exaggerated for an efficient description of the technical contents.

Further, in the various embodiments of the present specification, terms such as first, second, and third are used to describe various elements, but the elements are not limited to the terms. The terms are used only to distinguish one element from another element. Accordingly, an element mentioned as a first element in one embodiment may be mentioned as a second element in another embodiment. Each of the embodiments described and illustrated herein also includes their complementary embodiments. Further, the term “and/or” in the specification is used to include at least one of the elements enumerated in the specification.

In the specification, the terms of a singular form may include plural forms unless otherwise specified. Further, the terms “including” and “having” are used to designate that the features, the numbers, the steps, the elements, or combinations thereof described in the specification are present, and are not to be understood as excluding the possibility that one or more other features, numbers, steps, elements, or combinations thereof may be present or added.

Further, in the following description of the present invention, a detailed description of known functions and configurations incorporated herein will be omitted when it may make the subject matter of the present invention unnecessarily unclear.

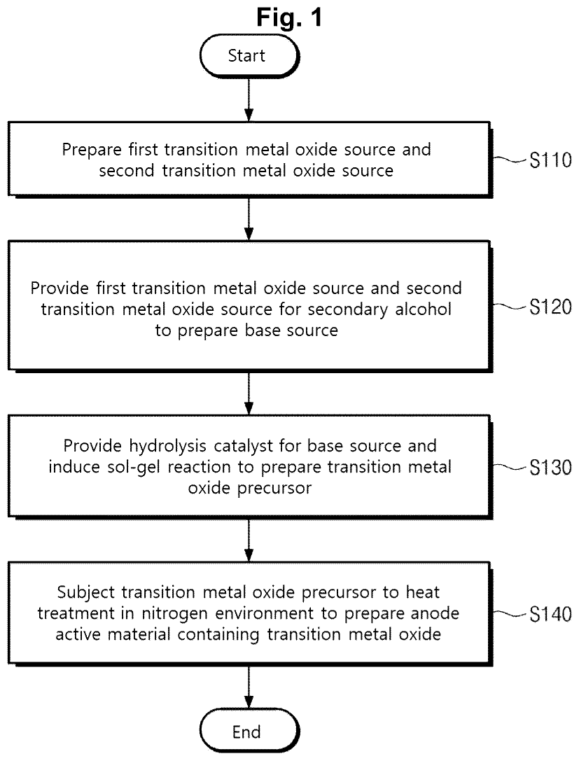

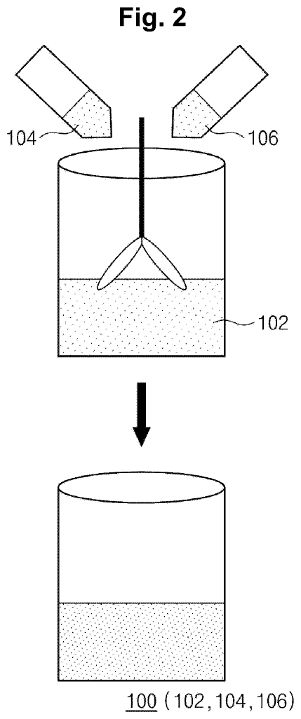

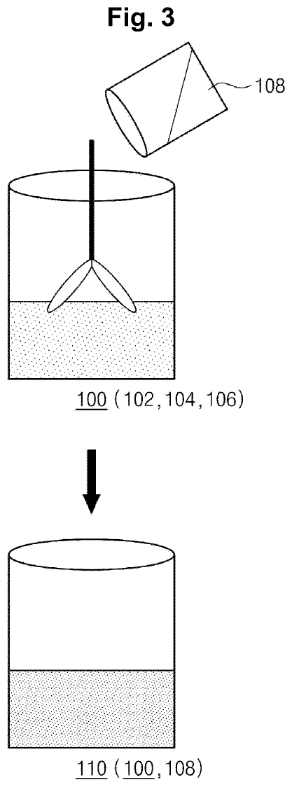

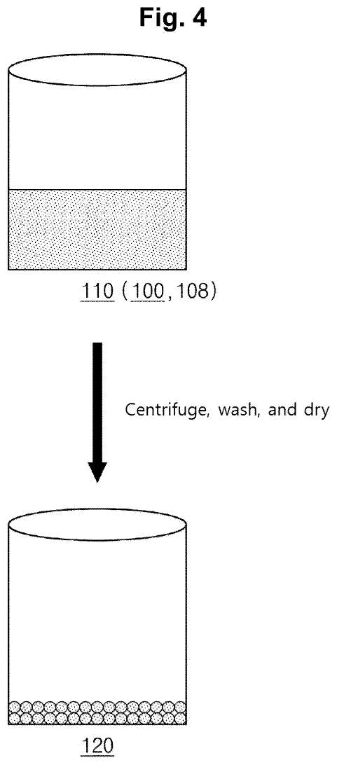

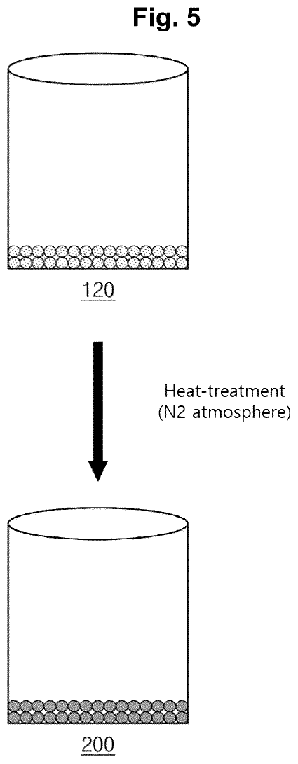

FIG. 1 is a flowchart for explaining a method for preparing an anode active material according to the first embodiment of the present invention, FIG. 2 is a view for explaining a step of preparing a base source of a transition metal oxide precursor in the method for preparing an anode active material according to the first embodiment of the present invention, FIGS. 3 to 4 are views for explaining a step of preparing a transition metal oxide precursor in the method for preparing an anode-active material according to the first embodiment of the present invention, FIG. 5 is a view for explaining a step of preparing an anode-active material according to the first embodiment of the present invention, and FIG. 6 is a view for explaining an anode active material according to the first embodiment of the present invention.

Referring to FIG. 1, a first transition metal oxide source 104 and a second transition metal oxide source 106 may be prepared (S110).

For example, the first transition metal oxide source 104 may be titanium butoxide, for example, the second transition metal oxide source 106 may be niobium ethoxide. Accordingly, as described below, transition metal atoms Ti and Nb and oxygen atom O may be derived from the first transition metal oxide source 104 and the second transition metal oxide source 106, and thus an anode active material 200 having a chemical composition of TiNbO₄ may be prepared.

According to one embodiment, the first transition metal oxide source 104 and the second transition metal oxide source 106 may be provided in a syringe.

Referring to FIGS. 1 and 2, the first transition metal oxide source 104 and the second transition metal oxide source 106 may be provided for a secondary alcohol 102 to prepare a base source 100 (S120).

According to one embodiment, the base source 100 may be prepared by dropping the first transition metal oxide source 104 and the second transition metal oxide source 106 through a syringe and mixing while stirring the secondary alcohol 102.

The base source 100 may include the transition metal atoms Ti and Nb and the oxygen atom O by the first transition metal oxide source 104 and the second transition metal oxide source 106.

The secondary alcohol 102 may not only control particles in the anode active material 200 to be described below to have a nano size, but also uniformly provide carbon atoms on the surface and inside of the particles in the anode active material 200. For example, the secondary alcohol 102 may be any one of ethylene glycol, diethylene glycol, or triethylene glycol.

Referring to FIGS. 1 to 4, a hydrolysis catalyst 108 may be provided to the base source 100 and a sol-gel reaction may be induced to prepare a transition metal oxide aggregate 110, and the transition metal oxide aggregate 110 may be centrifuged, washed, and dried to prepare a transition metal oxide precursor 120 (S140).

According to one embodiment, the hydrolysis catalyst 108 may be provided for the base source 100 and stirred for one hour to prepare the transition metal oxide aggregate 110. For example, the hydrolysis catalyst 108 may be any one of tetrahydrofuran (THF) or acetone including distilled water.

More specifically, a sol-gel reaction may be induced by the distilled water included in the acetone provided for the base source 100, and thus the transition metal oxide aggregate 110 in a gel state may be prepared. The transition metal oxide aggregate 110 may be glycolate including the transition metal atoms Ti and Nb and the oxygen atom O by the base source 110.

In addition, when the acetone including the distilled water is provided for the base source 100 and stirred for one hour, the weight ratio of the distilled water may be 1 wt %.

In contrast, when the weight ratio of the distilled water included in the acetone exceeds 1 wt %, a particle size of the anode active material 200 to be described later may increase to a nano size or more. In addition, when the weight ratio of the distilled water included in the acetone is less than 1 wt %, the surface roughness of particles of the anode active material 200 to be described later may increase.

However, the weight ratio of the distilled water included in the acetone may be controlled to be 1 wt % in the method for preparing the anode active material 200 according to the first embodiment of the present invention. Accordingly, the particles in the anode active material 200 to be described below may maintain a nano size and have a low surface roughness.

According to one embodiment, the transition metal oxide aggregate 110 may be subjected to a centrifuge to separate a solid phase from the transition metal oxide aggregate 110, and the solid phase may be washed three times or more with an organic solvent and dried in a box oven to prepare the transition metal oxide precursor 120. For example, the organic solvent may be ethanol. For example, the drying temperature of the box oven may be 60° C.

The transition metal oxide precursor 120 may be glycolate including the transition metal atoms Ti and Nb and the oxygen atom O and may have an amorphous crystal structure.

Referring to FIGS. 1 and 5, the transition metal oxide precursor 120 may be subjected to heat treatment to prepare the anode active material 200 including the transition metal oxide (S140).

According to one embodiment, the anode active material 200 having a crystalline crystal structure may be prepared by providing the transition metal oxide precursor 120 having an amorphous crystal structure to a tube furnace, increasing a heat treatment temperature to a temperature of more than 550° C. in a nitrogen environment, and subjecting the transition metal oxide precursor 120 to heat treatment. For example, a heating rate may be 10° C./min. For example, a heat treatment time may be two hours. In this case, the anode active material 200 being generated may have a chemical composition of TiNbO₄ by glycolate including the oxygen atom O and the transition metal atoms Ti and Nb of the transition metal oxide precursor 120.

In contrast, when the transition metal oxide precursor 120 is warmed to a temperature of 550° C. or less in a nitrogen environment and the transition metal oxide precursor 120 is subjected to heat treatment, a chemical composition of the anode active material 200 being generated may be different from TiNbO₄.

However, in the method for preparing the anode active material 200 according to the first embodiment of the present invention, the transition metal oxide precursor 120 may be warmed and subjected to heat treatment at a temperature of more than 550° C. in a nitrogen environment. Accordingly, the anode active material 200 being generated may have a chemical composition of TiNbO₄.

According to one embodiment, as the temperature at which the transition metal oxide precursor 120 is subjected to heat treatment increases, the surface roughness of particles of the anode active material 200 being generated may increase. In contrast, as the temperature at which the transition metal oxide precursor 120 is subjected to heat treatment decreases, the surface roughness of particles of the anode active material 200 being generated may decrease.

In addition, as the temperature at which the transition metal oxide precursor 120 is subjected to heat treatment increases, the grain size of the anode active material 200 being generated may increase, and thus the crystallinity of the anode active material 200 may increase. In contrast, as the temperature at which the transition metal oxide precursor 120 is subjected to heat treatment decreases, the grain size of the anode active material 200 being generated may decrease, and thus the crystallinity of the anode active material 200 may decrease.

In addition, as the temperature at which the transition metal oxide precursor 120 is subjected to heat treatment increases, the carbon atom content of the anode active material 200 being generated may decrease. Thus, an oxygen vacancy may decrease in the anode active material 200. In contrast, as the temperature at which the transition metal oxide precursor 120 is subjected to heat treatment decreases, the carbon atom content of the anode active material 200 being generated may increase. Thus, an oxygen vacancy may increase in the anode active material 200.

In addition, as the temperature at which the transition metal oxide precursor 120 is subjected to heat treatment increases, the pore size may increase in the anode active material 200. In contrast, as the temperature at which the transition metal oxide precursor 120 is subjected to heat treatment decreases, the pore size may decrease in the anode active material 200.

Consequently, in the method for preparing the anode active material 200 according to the first embodiment of the present invention, the surface roughness, carbon atom content, and pore size of particles of the anode active material 200 being generated may be controlled by controlling a temperature at which the transition metal oxide precursor 120 is subjected to heat treatment.

Referring to FIG. 6, the structure and properties of the anode active material 200 will be described.

As described above, the anode active material 200 may include particle 210 having a chemical composition of TiNbO₄ by the first transition metal oxide source 104, and the oxygen atoms O and the transition metal atoms Ti and Nb derived from the second transition metal oxide source 106. More specifically, the particle 210 may have a tetragonal crystal structure and a rutile crystal structure, and the size of the particle 210 may be 200 nm to 300 nm. In addition, particle 210 may include a carbon atom 240 on the surface and inside of the particle 210 and may include a pore 230 in the particle 210.

Accordingly, the anode active material 200 may have stability with respect to volume and volumetric strain of the crystal structure at the time of intercalation and deintercalation of lithium ions due to the crystal structure of the particles 210. In addition, the anode active material 200 may have an improved electrical conductivity and may quickly move electrons due to the carbon atoms 240 of the particles 210. Furthermore, the anode active material 200 may provide a space for accommodating lithium ions having a larger surface area capable of reacting with the lithium ions and shortening the diffusion distance of the lithium ions due to the pores 230 of the particles 210.

Thus, when a lithium secondary battery to be described later is manufactured using the anode active material 200 including the particles 210, the performance of the lithium secondary battery may be improved.

An anode electrode may be prepared using the anode active material according to the first embodiment of the present invention described above. Hereinafter, a method for preparing the anode electrode according to the first embodiment of the present invention will be described.

The anode active material 200 was prepared according to the first embodiment of the present invention described with reference to FIGS. 1 to 6 may be provided.

The method for preparing the anode electrode may include providing the anode active material 200 for a polymer binder, stirring to prepare a slurry, and coating the slurry on a current collector to prepare an anode electrode. For example, the polymer binder may be polyvinylidene fluoride. For example, the current collector may be a copper foil.

A lithium secondary battery may be manufactured using the anode electrode according to the first embodiment of the present invention described above. Hereinafter, the structure and properties of the lithium secondary battery according to the first embodiment of the present invention will be described.

The lithium secondary battery may include the anode electrode prepared according to the first embodiment of the present invention, a cathode electrode disposed on the anode electrode and including lithium, and an electrolyte between the anode electrode and the cathode electrode.

The anode electrode may include the anode active material 200 prepared according to the first embodiment of the present invention.

The anode active material 200 is described with reference to FIGS. 1 to 6 may include particle 210 as described above. More specifically, the particle 210 may have a nano size and have tetragonal and rutile crystal structures which are formed of transition metal atoms Ti and Nb and oxygen atom O. In addition, particle 210 may include a carbon atom 240 on the surface and inside of the particle 210 and may include a pore 230 in the particle 210.

Accordingly, the anode active material 200 may have stability with respect to volume and volumetric strain of the crystal structure at the time of intercalation and deintercalation of lithium ions in the electrolyte due to the crystal structure of the particle 210. In addition, the anode active material 200 may provide a space for accommodating a larger number of the lithium ions by increasing a surface area capable of reacting with the lithium ions and shortening the diffusion distance of the lithium ions due to the pores 230 in the particles 210. Accordingly, the intercalation and deintercalation of the lithium ions may easily occur. In addition, the anode active material 200 may have an improved electrical conductivity and may quickly move electrons due to the carbon atoms 240 on the surface and inside of the particles 210. Accordingly, the lithium secondary battery including the anode active material 200 may have high efficiency, high reliability, and stability in a charge/discharge cycle for a long period of time.

In addition, the lithium secondary battery may easily move the lithium ions and electrons in a long charge/discharge cycle of the lithium secondary battery due to the size of the particle 210 of the anode active material 200 as well as the carbon atoms 240 on the surface and inside of the particles 210. Accordingly, the lithium secondary battery may have a negative fading property in which a specific capacity of the lithium secondary battery is improved as the number of charge/discharge cycles of the lithium secondary battery increases.

An anode-active material according to a second embodiment of the present invention may be prepared, unlike the anode-active material according to the first embodiment of the present invention described above. Hereinafter, a method for preparing the anode active material according to the second embodiment of the present invention will be described.

A method for preparing the anode active material may include: preparing a first transition metal oxide source and a second transition metal oxide source; providing the first transition metal oxide source and the second transition metal oxide source for a weakly basic solution and a weakly acidic solution and inducing a sol-gel reaction to prepare a base source; removing the weakly basic solution from the base source and ball milling to prepare a transition metal oxide precursor; and subjecting the transition metal oxide precursor to heat treatment in a nitrogen environment to prepare an anode active material containing a transition metal oxide.

The first transition metal oxide source and the second transition metal oxide source may be prepared.

According to one embodiment, the first transition metal oxide source and the second transition metal oxide source may be the same as the first transition metal oxide source 104 and the second transition metal oxide source 106 according to the first embodiment of the present invention. Accordingly, as described below, transition metal atoms Ti and Nb and oxygen atom O may be derived from the first transition metal oxide source and the second transition metal oxide source, and thus the anode active material having a chemical composition of TiNbO₄ may be prepared.

According to one embodiment, the first transition metal oxide source and the second transition metal oxide source may be provided in a syringe.

The base source may be prepared by providing the first transition metal oxide source and the second transition metal oxide source for the weakly basic solution and the weakly acidic solution and inducing a sol-gel reaction.

According to one embodiment, the base source may be prepared by providing the weakly acidic solution for the weakly basic solution, and then dropping the first transition metal oxide source and the second transition metal oxide source through a syringe and stirring the resulting mixture. For example, the weakly basic solution may be ethanol (C₂H₅OH). For example, the weakly acidic solution may be any one of acetic acid (CH₃COOH), formic acid (HOOH), or trichloroacetic acid (CCl₃COOH). More specifically, a part of the weakly basic solution and the weakly acidic solution may be neutralized to generate water in a process of providing the weakly acidic solution for the weakly basic solution, injecting the first transition metal oxide source and the second transition metal oxide source through a syringe, and stirring the resulting mixture. Accordingly, hydrolysis and a sol-gel reaction may be induced by the water, and thus the base source in a gel state may be prepared. The base source may include the transition metal atoms Ti and Nb and the oxygen atom O by the first transition metal oxide source and the second transition metal oxide.

The weakly basic solution may be removed from the base source and ball milled to prepare the transition metal oxide precursor.

According to one embodiment, the weakly basic solution remaining in the base source above may be removed by stirring for a long time. In addition, the base source from which the weakly basic solution is removed may be ball-milled to prepare the transition metal oxide precursor in a solid-gel state. For example, the time for stirring the base source in a gel state may be two hours or more. Accordingly, the base source in a gel state may be prepared from the transition metal oxide precursor in a powder state including the transition metal atoms Ti and Nb and the oxygen atom (O).

The transition metal oxide precursor may be subjected to heat treatment in a nitrogen environment to prepare the anode active material containing a transition metal oxide.

According to one embodiment, the anode active material may be prepared by heating the transition metal oxide precursor to a temperature of 600° C. to 900° C. in a nitrogen environment and subjecting the transition metal oxide precursor to heat treatment. For example, a heating rate may be 10° C./min. For example, a heat treatment time may be two hours. In this case, the anode active material being generated may have a chemical composition of TiNbO₄ by the oxygen atom O and the transition metal atoms Ti and Nb of the transition metal oxide precursor. In addition, the particles of the anode active material may have a bulk form.

According to one embodiment, the crystallinity of the particles of the anode active material may increase due to an increase in the grain size of the particles of the anode active material being generated as the temperature at which the transition metal oxide precursor is subjected to heat treatment increases. In contrast, the crystallinity of the particles of the anode active material may decrease due to a decrease in the grain size of the particles of the anode active material being generated as the temperature at which the transition metal oxide precursor is subjected to heat treatment decreases.

In addition, the carbon atom content of the particles of the anode active material may decrease as the temperature at which the transition metal oxide precursor is subjected to heat treatment increases. Accordingly, an oxygen vacancy may decrease in the particles of the anode active material. In contrast, the carbon atom content of the particles of the anode active material may increase as the temperature at which the transition metal oxide precursor is subjected to heat treatment decreases. Accordingly, an oxygen vacancy may increase in the anode active material.

Consequently, in the method for preparing the anode active material according to the second embodiment of the present invention, the crystallinity and oxygen vacancy of the particles of the anode active material may be controlled by controlling a temperature at which the transition metal oxide precursor is subjected to heat treatment.

As described above, the anode active material being generated may include particles having a chemical composition of TiNbO₄ by the first transition metal oxide source, and the oxygen atom O and the transition metal atoms Ti and Nb derived from the second transition metal oxide source. More specifically, the particle may have a bulk form having tetragonal and rutile crystal structures. And, the particle may include an oxygen vacancy on the surface and inside of the particle.

Thus, the anode active material may have stability with respect to the volume and volumetric strain of the crystal structure at the time of intercalation and deintercalation of lithium ions due to the crystal structure of the particles. In addition, the anode active material may have an improved electrical conductivity and may quickly move electrons due to the oxygen vacancy of the particles.

Accordingly, when a lithium secondary battery to be described later is manufactured using the anode active material including the particles, the performance of the lithium secondary battery may be improved.

An anode electrode may be prepared using the anode active material according to the second embodiment of the present invention described above. Hereinafter, a method for preparing the anode electrode according to the second embodiment of the present invention will be described.

The anode active material prepared according to the second embodiment of the present invention may be provided.

The method for preparing the anode electrode may include providing the anode active material for a polymer binder, stirring to prepare a slurry, and coating the slurry on a current collector to prepare an anode electrode. For example, the polymer binder may be polyvinylidene fluoride. For example, the current collector may be a copper foil.

A lithium secondary battery may be manufactured using the anode electrode according to the second embodiment of the present invention described above. Hereinafter, the structure and properties of the lithium secondary battery according to the second embodiment of the present invention will be described.

The lithium secondary battery may include the anode electrode prepared according to the second embodiment of the present invention, a cathode electrode disposed on the anode electrode and including lithium, and an electrolyte between the anode electrode and the cathode electrode.

The anode electrode as described above may include the anode active material prepared according to the second embodiment of the present invention.

The anode active material may include particles as described above. More specifically, the particle may have a bulk form and have tetragonal and rutile crystal structures which are formed of transition metal atoms Ti and Nb and oxygen atom O. In addition, the particle may include an oxygen vacancy on the surface and inside of the particle.

Thus, the anode active material may have stability with respect to volume and volumetric strain of the crystal structure at the time of intercalation and deintercalation of lithium ions in the electrolyte due to the crystal structure of the particle. Accordingly, the intercalation and deintercalation of the lithium ions may easily occur. In addition, the anode active material may have an improved electrical conductivity and may quickly move electrons due to the oxygen vacancy on the surface and inside of the particle. Accordingly, the lithium secondary battery including the anode active material may have high efficiency, high reliability, and stability in a charge/discharge cycle for a long period of time.

Hereinafter, specific experimental examples and property evaluation of the anode active material, the anode electrode, and the lithium secondary battery according to the embodiments of the present invention will be described.

Anode active material according to Experimental Examples 1-1 to 1-8 (Ex 1-1 to Ex 1-8), anode electrode according to Experimental Examples 1-3 to 1-8, and method for manufacturing lithium secondary half-battery

### Anode Active Material

Titanium butoxide as a first transition metal oxide source, niobium ethoxide as a second transition metal oxide source, ethylene glycol as a secondary alcohol, and acetone (acetone 99.0 vol %+D.I water 1.0 vol %) as a hydrolysis catalyst were prepared.

In a glove box, 40 ml of the ethylene glycol was provided to a 300 ml beaker, and then the titanium butoxide and the niobium ethoxide were injected therein through a syringe in an amount of 0.05 ml and 0.04 ml, respectively, while stirring at 500 rpm, sealed with a parafilm, and then stirred for 30 minutes to prepare a base source.

After that, acetone was provided to the base source and stirred for one hour. Then, a solid phase of the base source was centrifuged using a centrifuge, washed three times or more with ethanol, and dried at 60° C. in a box oven to prepare a transition metal oxide precursor.

After that, the transition metal oxide precursor was provided to a tube furnace in a nitrogen environment and subjected to heat treatment for two hours. Specifically, the temperature for heat treatment of the transition metal oxide precursor varied from 250° C. to 900° C. as shown in <Table 1> below, The temperature was raised at 10° C./min up to the temperature for heat treatment, and the heat treatment was performed for two hours, to prepare the anode active materials according to Experimental Examples 1-1 to 1-8. The anode active materials according to Experimental Examples 1-1 to 1-8 were prepared by varying only the temperature for heat treatment of the transition metal oxide precursor.

### Method for Preparing Anode Electrode

Anode active materials according to Experimental Examples 1-3 to 1-8, Super P as a conductive material, polyvinylidene fluoride (PVDF) as a binder, N-methyl-2-pyrrolidone (NMP) as a solvent, and a copper foil as a current collector were prepared.

The anode active materials, the Super P, and the PVDF were mixed at a ratio of 6:2:2 and stirred using a Thinky mixer, and then the NMP was provided and stirred to prepare an anode slurry.

After that, the anode slurry was applied onto the copper foil by using a doctor blade, and dried in a box oven at 120° C. for 12 hours, so as to prepare anode electrodes according to Experimental Examples 1-3 to 1-8.

### Method for Manufacturing Lithium Secondary Half-Battery

Anode electrodes according to Experimental Examples 1-3 to 1-8, lithium foil as a cathode electrode, and ethylene carbonate (EC), dimethyl methyl carbonate (DMC), and LiPF₆ as electrolytes were prepared.

The electrolyte was prepared by adding and mixing the LiPF₆ to a solution in which the EC and the DMC were mixed at a ratio of 1:1.

Then, in a glove box, the electrolyte was provided between the anode electrode and the cathode electrode, to manufacture half-batteries according to Experimental Examples 1-3 to 1-8.

TABLE 1

| | Temperature for heat |
|---|---|
| | treatment of transition |
| Classification | metal oxide precursor |
| Experimental Example 1-3 (Ex 1-3) | 450° C. |
| Experimental Example 1-4 (Ex 1-4) | 550° C. |
| Experimental Example 1-5 (Ex 1-5) | 600° C. |
| Experimental Example 1-6 (Ex 1-6) | 700° C. |
| Experimental Example 1-7 (Ex 1-7) | 800° C. |
| Experimental Example 1-8 (Ex 1-8) | 900° C. |

Method for preparing film structure having micro channels according to Experimental Examples 2-1 to 2-4

### Anode Active Material

Titanium butoxide as a first transition metal oxide source, niobium ethoxide as a second transition metal oxide source, and ethanol and acetic acid as solutions to induce a sol-gel reaction were prepared.

In a glove box, 25 ml of the ethanol and 8 ml of the acetic acid were sequentially provided to a 300 ml beaker.

After that, the titanium butoxide and the niobium ethoxide were injected into the ethanol and the acetic acid through a syringe in an amount of 0.4 ml and 0.288 ml, respectively, sealed with a parafilm, and then stirred for two hours to prepare a base source.

Then, the parafilm was removed from the beaker, and the base source was stirred to evaporate the ethanol in the base source, and then ball-milled to prepare a transition metal oxide precursor.

After that, the transition metal oxide precursor was provided to a tube furnace in a nitrogen environment and subjected to heat treatment for two hours. Specifically, the temperature for heat treatment of the transition metal oxide precursor varied from 600° C. to 900° C. as shown in <Table 2> below, The temperature was raised at 10° C./min up to the temperature for heat treatment, and the heat treatment was performed for two hours, to prepare the anode active material according to Experimental Examples 2-1 to 2-4. The anode active materials according to Experimental Examples 2-1 to 2-4 were prepared by varying only the temperature for heat treatment of the transition metal oxide precursor.

### Method for Preparing Anode Electrode

Anode active materials according to Experimental Examples 2-1 to 2-4, Super P as a conductive material, polyvinylidene fluoride (PVDF) as a binder, N-methyl-2-pyrrolidone (NMP) as a solvent, and a copper foil as a current collector were prepared.

The anode active materials, the Super P, and the PVDF were mixed at a ratio of 7:2:1 and stirred using a Thinky mixer, and then the NMP was further provided and stirred to prepare an anode slurry.

After that, the anode slurry was coated onto the copper foil by using a doctor blade, and dried in a box oven at 120° C. for 12 hours, to prepare anode electrodes according to Experimental Examples 2-1 to 2-4.

### Method for Manufacturing Lithium Half-Battery

The anode electrodes according to Experimental Examples 2-1 to 2-4, lithium foil as a cathode electrode, and ethylene carbonate (EC), ethyl methyl carbonate (EMC), and LiPF₆ as electrolytes were prepared.

The electrolyte was prepared by adding and stirring the LiPF₆ to a solution in which the EC and the EMC were mixed at a ratio of 1:1.

Then, in a glove box, the electrolyte was provided between the anode electrode and the cathode electrode, to manufacture half-batteries according to Experimental Examples 2-1 to 2-4.

TABLE 2

| | Temperature for heat |
|---|---|
| | treatment of transition |
| Classification | metal oxide precursor |
| Experimental Example 2-1 (Ex 2-1) | 600° C. |
| Experimental Example 2-2 (Ex 2-2) | 700° C. |
| Experimental Example 2-3 (Ex 2-3) | 800° C. |
| Experimental Example 2-4 (Ex 2-4) | 900° C. |

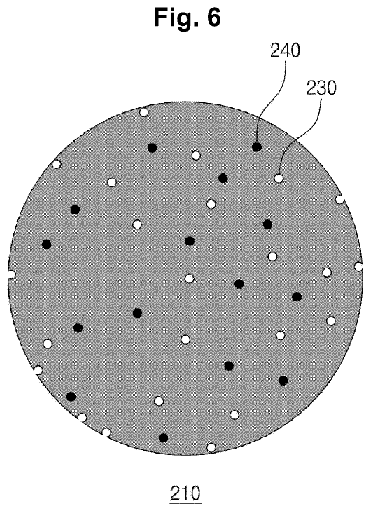

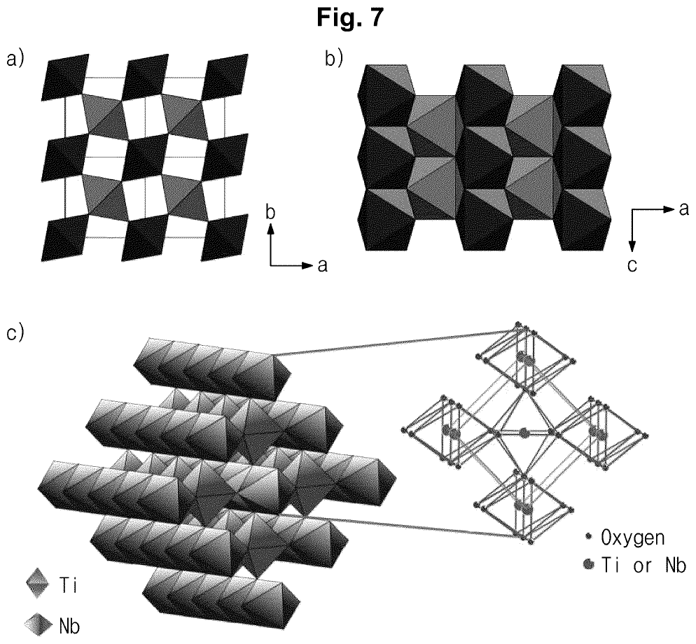

FIG. 7 is a view showing a crystal structure of particles of anode active materials according to experimental examples of the present invention.

Referring to FIG. 7, particles of the anode active materials according to Experimental Examples 1-5 to 1-8 and Experimental Examples 2-1 to 2-4 have a chemical composition of TiNbO₄ including transition metal atoms Ti and Nb and oxygen atom O.

As can be understood from FIG. 7, it can be seen that the particles of the anode active materials according to experimental examples (Experimental Examples 1-5 to 1-8, and Experimental Examples 2-1 to 2-4) of the present invention have tetragonal and rutile crystal structures.

Thus, it can be seen that when the lithium secondary battery manufactured using the anode active material is subjected to a charge/discharge cycle for a long period of time, intercalation and deintercalation of lithium ions easily occur in the anode active material. Accordingly, it can be seen that the lithium secondary battery has stability for a charge/discharge cycle for a long period of time.

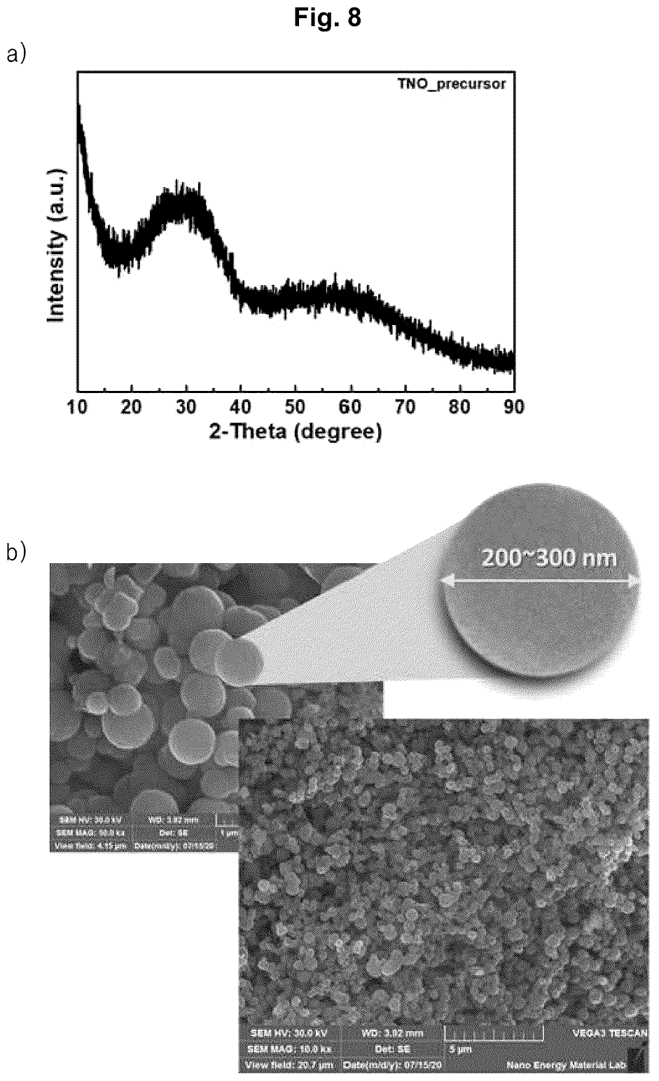

FIG. 8 is an XRD graph of transition metal oxide precursors and an SEM picture of anode active materials according to experimental examples of the present invention.

Referring to FIG. 8, (a) of FIG. 8 showed an XRD analysis of the transition metal oxide precursors according to experimental examples, and (b) of FIG. 8 showed an SEM picture of the particles of the anode active materials according to experimental examples.

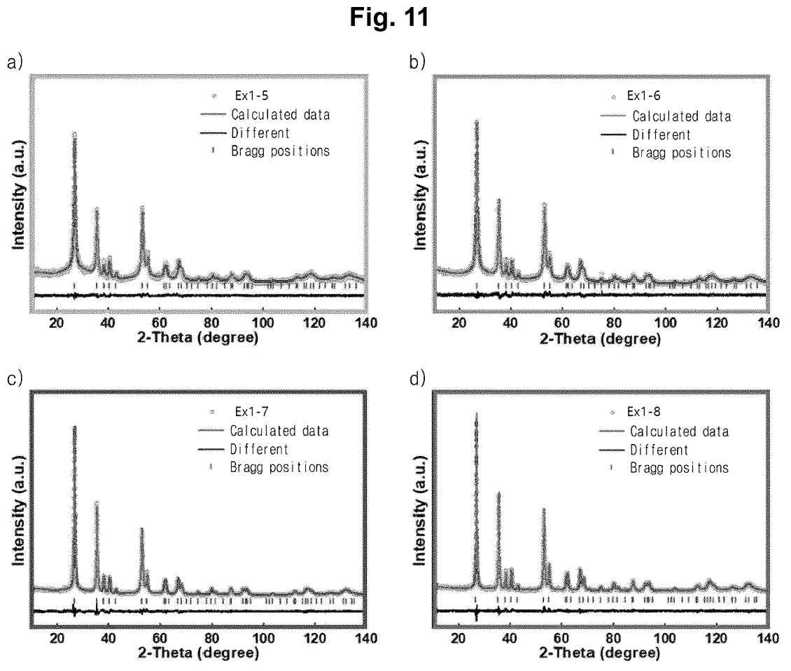

As can be understood from FIG. 8, it can be seen that the amorphous transition metal oxide precursor is subjected to heat treatment in a nitrogen atmosphere and thus is prepared as the crystalline anode active material, when comparing the graph (a) of FIG. 8 and the graph (a) of FIG. 11 to be described later (an XRD analysis graph of the anode active material according to Experimental Example 1-5). Then, it can be seen that the particles of the crystalline anode active material have a spherical shape, and the size of the particles of the anode active material is 200 nm to 300 nm.

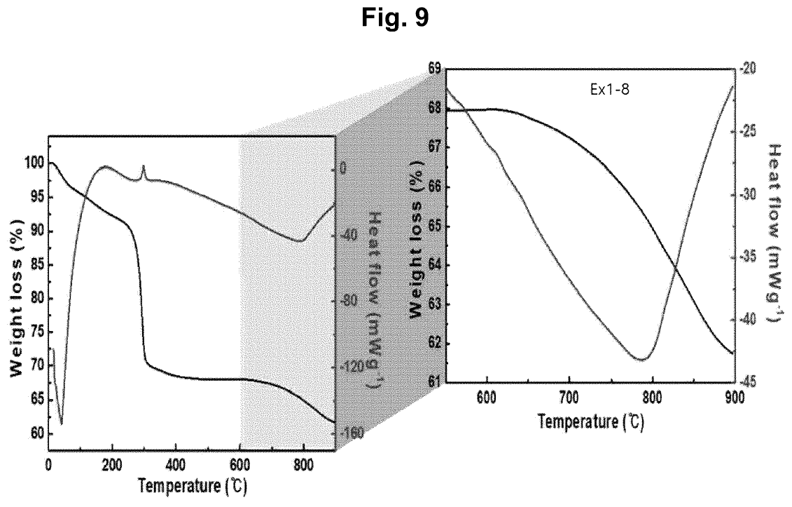

FIG. 9 is a graph analyzing through TGA equipment a heat treatment process for transition metal oxide precursors according to experimental examples of the present invention.

Referring to FIG. 9, a change in weight by temperature was measured by TGA in a process of raising the temperature of the transition metal oxide precursors according to experimental examples.

As can be understood from FIG. 9, it can be seen that ethanol and water are vaporized and removed in the transition metal oxide precursor around 100° C., organic materials are oxidized and removed in the transition metal oxide precursor around 300° C., and carbon elements remaining in the transition metal oxide precursor are oxidized and removed after 600° C.

Thus, it can be seen that the weight of the transition metal oxide precursor decreases after heat treatment. More specifically, a reduced weight ratio of the transition metal oxide precursor according to Experimental Examples 1-8 and a reduced weight ratio of the transition metal oxide precursors according to Experimental Examples 1-3 to 1-8 were measured as shown in <Table 3> below.

TABLE 3

| | Temperature | Weight ratio | Reduced weight |
|---|---|---|---|
| | of heat | after heat | ratio after heat |
| Classification | treatment | treatment | treatment |
| Experimental | 450° C. | 68.13% | 31.87% |
| Example 1-3 | | | |
| Experimental | 550° C. | 67.99% | 32.01% |
| Example 1-4 | | | |
| Experimental | 600° C. | 67.97% | 32.03% |
| Example 1-5 | | | |
| Experimental | 700° C. | 67.25% | 32.75% |
| Example 1-6 | | | |
| Experimental | 800° C. | 64.94% | 35.06% |
| Example 1-7 | | | |
| Experimental | 900° C. | 61.69% | 38.31% |
| Example 1-8 | | | |

As can be understood from above <Table 3>, it can be seen that the weight reduction ratio of the transition metal oxide precursor increases as the temperature for heat treatment of the transition metal oxide precursor according to experimental examples increases.

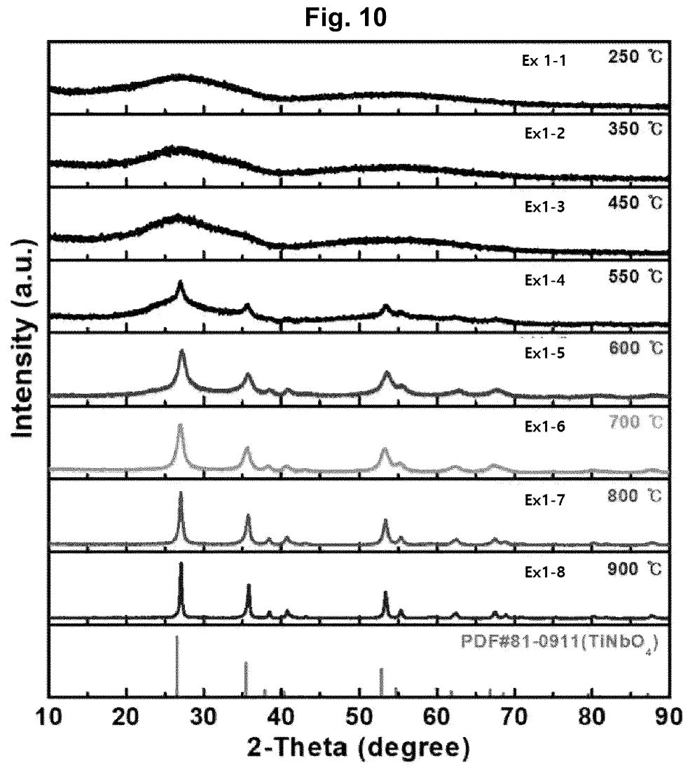

FIGS. 10 and 11 are graphs of analyzing through XRD anode active materials according to experimental examples of the present invention.

Referring to FIGS. 10 and 11, the anode active materials according to Experimental Examples 1-1 to 1-8 prepared by varying only a temperature for heat treatment of the transition metal oxide precursor were analyzed by XRD.

As can be understood from FIGS. 10 and 11, when the transition metal oxide precursor is subjected to heat treatment at a temperature of more than 550° C., it can be seen that a TiNbO₄ peak occurs in the anode active material. Thus, when the transition metal oxide precursor is subjected to heat treatment at a temperature of more than 550° C., it can be seen that the chemical composition of the anode active material being generated is TiNbO₄.

Then, in the anode active materials according to Experimental Examples 1-5 to 1-8, it can be confirmed that the intensity of the TiNbO₄ peak becomes stronger as the temperature for heat treatment of the transition metal oxide precursor increases.

FIG. 12 is a view showing SEM pictures and TEM pictures of anode active materials according to Experimental Examples 1-5 to 1-8 of the present invention.

Referring to FIG. 12, (a) of FIG. 12 showed an SEM picture of the particles of the anode active materials according to Experimental Examples 1-5 to 1-8, and (b) of FIG. 12 showed a TEM picture of pores in the particles of the anode active materials according to Experimental Examples 1-5 to 1-8.

As can be understood from FIG. 12, it can be seen the surface roughness of the particles of the anode active material according to Experimental Examples 1-5 is the lowest, and it can be seen that the surface roughness of the particles of the anode active materials increases in an order of increasing a temperature for heat treatment when the anode active materials are prepared, that is, in the order of Experimental Examples 1-5, 1-6, 1-7 and 1-8.

In addition, it can be seen that the pore size of the particles of the anode active material according to Experimental Examples 1-5 is the smallest, and it can be seen that the pore size of the particles of the anode active materials increases in an order of increasing a temperature for heat treatment when the anode active material is prepared, that is, in the order of Experimental Examples 1-5, 1-6, 1-7 and 1-8.

Accordingly, when the lithium secondary battery manufactured using the anode active materials according to Experimental Examples 1-5 to 1-8 of the present invention is subjected to a charge/discharge cycle, it can be seen that a surface area capable of reacting with lithium ions is increased by the pores present in the anode active material, to provide a space for accommodating a more number of lithium ions as well as reduce a diffusion distance of lithium ions, thereby improving the efficiency of the lithium secondary battery.

FIG. 13 is a graph of analyzing through Raman spectroscopy anode active materials according to Experimental Embodiments 1-5 to 1-8 of the present invention.

Referring to FIG. 13, intensities of the D band and G band of the anode active materials according to Experimental Examples 1-5 to 1-8 were measured as shown in Table 4 below.

TABLE 4

| | Temperature of | |
|---|---|---|
| Classification | heat treatment | I_{D}/I_{G} |
| Experimental Example 1-5 | 600° C. | 0.992 |
| Experimental Example 1-6 | 700° C. | 0.996 |
| Experimental Example 1-7 | 800° C. | 1.000 |
| Experimental Example 1-8 | 900° C. | 1.001 |

As can be understood from FIG. 13 and <Table 4>, it can be seen that the anode active materials according to Experimental Examples 1-5 to 1-8 have a carbon element by peaks of the D band generated at 1,335 cm⁻¹ and G band generated at 1,570 cm⁻¹. Then, it can be seen that the intensity of peaks of the D band and G band of the anode active materials decreases in an order of increasing temperature for heat treatment when the anode active materials are prepared, that is, in the order of Experimental Examples 1-5, 1-6, 1-7 and 1-8.

Additionally, the carbon content of the anode active materials according to Experimental Examples 1-3 to 1-8 was measured as shown in <Table 5>below through EA analysis which quantitatively analyzes a molecular formula of compounds and the content of elements.

TABLE 5

| | Temperature of | Carbon |
|---|---|---|
| Classification | heat treatment | content |
| Experimental Example 1-3 | 450° C. | 10.25% |
| Experimental Example 1-4 | 550° C. | 10.41% |
| Experimental Example 1-5 | 600° C. | 9.62% |
| Experimental Example 1-6 | 700° C. | 9.11% |
| Experimental Example 1-7 | 800° C. | 6.96% |
| Experimental Example 1-8 | 900° C. | 6.32% |

It can be seen that the carbon content of the anode active material according to Experimental Example 1-3 is the highest, and it can be seen that the carbon content of the anode active materials decreases in an order of increasing a temperature for heat treatment when the anode active materials are prepared, that is, in the order of Experimental Examples 1-3, 1-4, 1-5, 1-6, 1-7 and 1-8. Carbon may have the effect of increasing electrical conductivity and quickly moving electrons. Thus, when the lithium secondary battery manufactured using the anode active materials including carbon according to Experimental Examples 1-5 to 1-8 of the present invention is subjected to a charge/discharge cycle, it can be seen that the electrochemical performance of the lithium secondary battery is improved. However, when the lithium secondary battery manufactured using the anode active materials according to Experimental Examples 1-3 and 1-4 is subjected to a charge/discharge cycle, it can be seen that remarkably unstable battery performance is exhibited as compared to when the lithium secondary battery manufactured using the anode active materials according to Experimental Examples 1-5 to 1-8 is subjected to a charge/discharge cycle.

When the lithium secondary batteries according to Experimental Examples 1-3 and 1-4 are subjected to a charge/discharge cycle, it can be understood that an unstable battery performance is caused by a crystal structure of the anode active materials according to Experimental Examples 1-3 and 1-4. Specifically, a binding force may be lower than that of the anode active materials according to Experimental Examples 10 1-5 to 1-8 due to an amorphous structure of the anode active materials according to Experimental Examples 1-3 and 1-4. Accordingly, when the lithium secondary batteries according to Experimental Examples 1-3 to 1-4 are subjected to a charge/discharge cycle, a crystal structure of the anode active material may be deformed, and thus the intercalation and deintercalation of lithium ions may not easily occur. Accordingly, an unstable battery performance may appear.

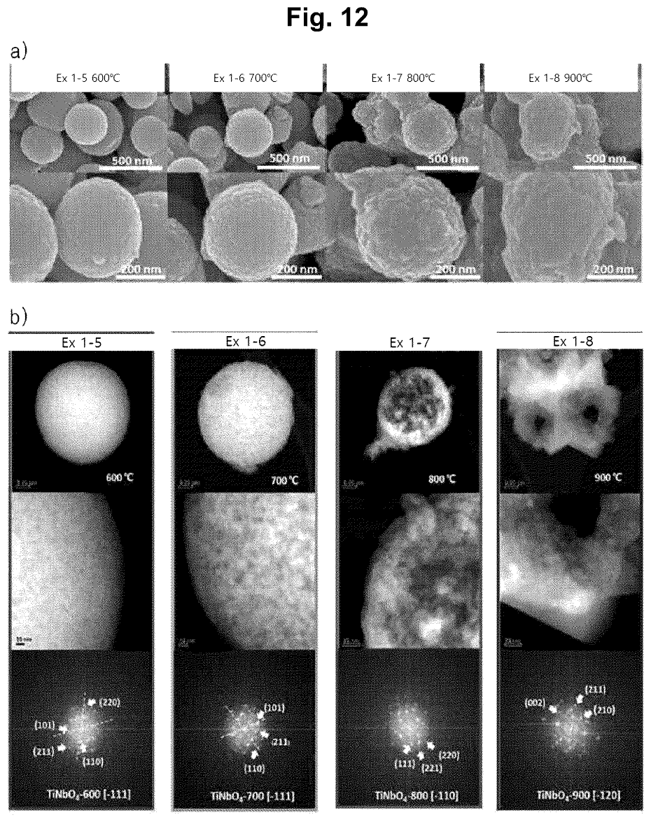

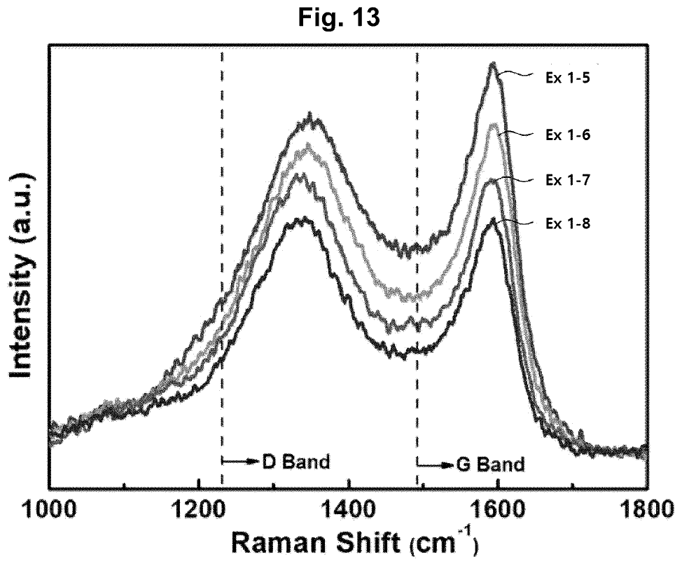

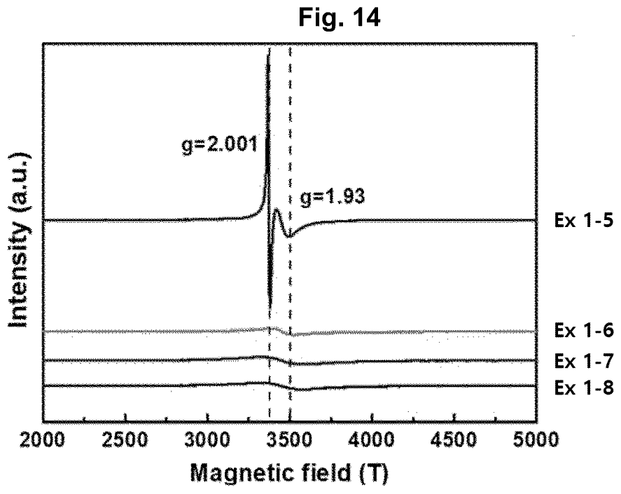

FIG. 14 is a graph of analyzing through electron paramagnetic resonance (EPR) anode active materials according to Experimental Embodiments 1-5 to 1-8 of the present invention.

Referring to FIG. 14, an oxygen vacancy of anode active materials according to Experimental Examples 1-5 to 1-8 was measured by EPR. On a graph, an intensity of the peak of g value (2.001) may be related to the oxygen vacancy.

As can be understood from FIG. 14, it can be seen that a peak intensity is the strongest with respect to the oxygen vacancy of the anode active material according to Experimental Examples 1-5.

Then, it can be seen that a peak intensity with respect to the oxygen vacancy decreases in an order of increasing a temperature for heat treatment when the anode active materials according to experimental examples are prepared, that is, in the order of Experimental Examples 1-5, 1-6, 1-7 and 1-8.

The oxygen vacancy may have the property of improving electrical conductivity through electron charge transfer. Thus, when the lithium secondary battery manufactured using the anode active materials including oxygen vacancies according to Experimental Examples 1-5 to 1-8 of the present invention is subjected to a charge/discharge cycle, it can be seen that an electrochemical performance of the lithium secondary battery is improved.

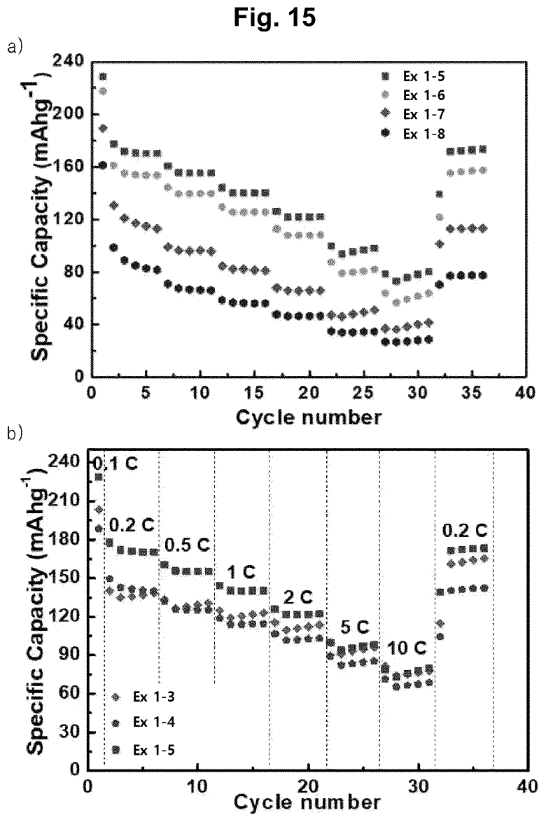

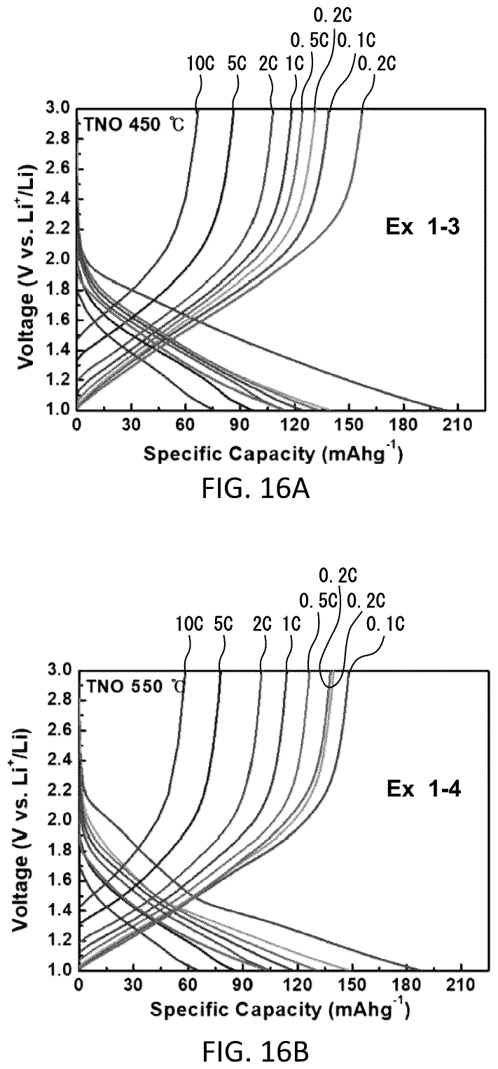

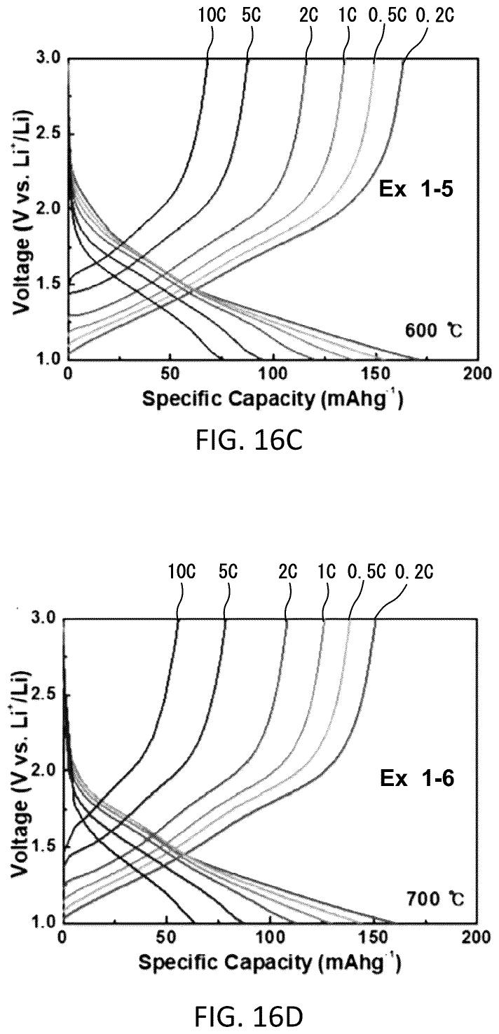

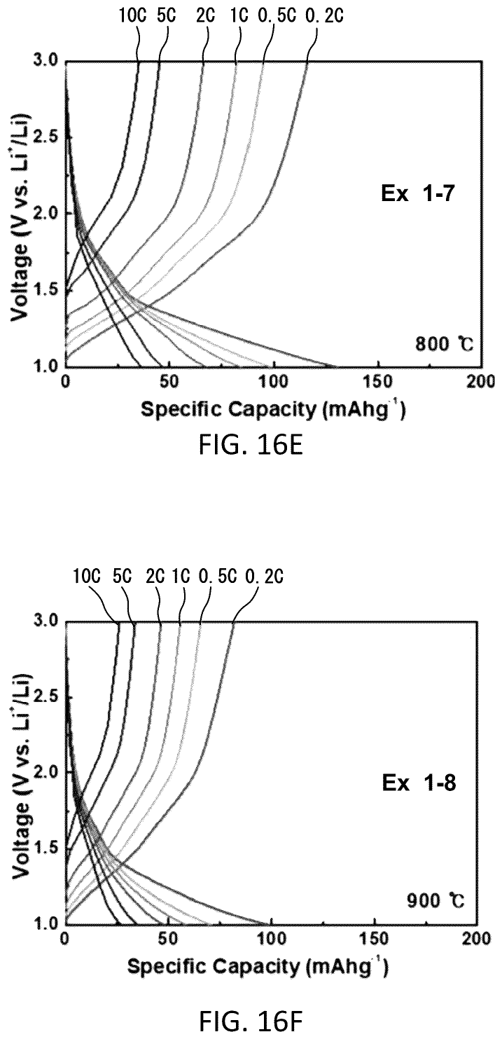

FIG. 15 is a graph measuring a specific capacity value for each C-rate during charging/discharging of lithium secondary half-batteries according to Experimental Examples 1-3 to 1-8 of the present invention, and FIGS. 16A through 16F are graphs measuring a voltage change value according to a specific capacity for each C-rate of lithium secondary half-batteries according to Experimental Examples 1-3 to 1-8 of the present invention.

Referring to FIG. 15, the lithium secondary half-batteries according to Experimental Examples 1-3 to 1-8 were provided with a current density of 0.1 C and subjected to charge/discharge once to form a solid-electrolyte interface (SEI), and then the lithium secondary half-batteries were provided with a current density of 0.2 C to 10 C and subjected to charge/discharge five times for each C-rate to measure a specific capacity value. A specific capacity value for each C-rate of the lithium secondary half-batteries according to Experimental Examples 1-5 to 1-8 was measured as shown in <Table 1> below.

TABLE 6

| | 0.1 C | 0.2 C | 0.5 C | 1.0 C | 5.0 C | 10.0 C |
|---|---|---|---|---|---|---|
| Classification | (mAhg⁻¹) | (mAhg⁻¹) | (mAhg⁻¹) | (mAhg⁻¹) | (mAhg⁻¹) | (mAhg⁻¹) |
| Experimental | 228.7 | 177.6 | 161.0 | 144.0 | 100.0 | 79.0 |
| Example 1-5 | | | | | | |
| Experimental | 217.6 | 161.1 | 145.0 | 130.0 | 88.0 | 64.0 |
| Example 1-6 | | | | | | |
| Experimental | 189.4 | 130.8 | 99.0 | 85.0 | 47.0 | 37.0 |
| Example 1-7 | | | | | | |
| Experimental | 161.2 | 98.7 | 71.0 | 58.0 | 35.0 | 27.0 |
| Example 1-8 | | | | | | |

Referring to FIGS. 16A through 16F, the lithium secondary half-batteries according to Experimental Examples 1-3 to 1-8 were provided with a current density of 0.2 C to 10 C as a galvanostatic charge and discharge profile, and a change in a voltage value according to specific capacity was measured at the time of one charge/discharge.

As can be understood from FIG. 15 and <Table 6>, it can be seen that the lithium secondary half-battery according to Experimental Example 1-5 has the highest specific capacity value in all C-rates (0.1 C to 10 C). Then, it can be seen that a specific capacity value at all the C-rates (0.1 C to 10 C) decreases in an order of increasing temperature for heat treatment when the anode active materials according to experimental examples are prepared, that is, in the order of Experimental Examples 1-5, 1-6, 1-7 and 1-8.

Then, as can be understood from FIGS. 16A through 16F, it can be seen that the anode active materials according to Experimental Examples 1-5 to 1-8 have a single phase depending on the distribution of voltage values according to a specific capacity for each C-rate in a process of charging and discharging the lithium secondary half-batteries according to Experimental Examples 1-5 to 1-8.

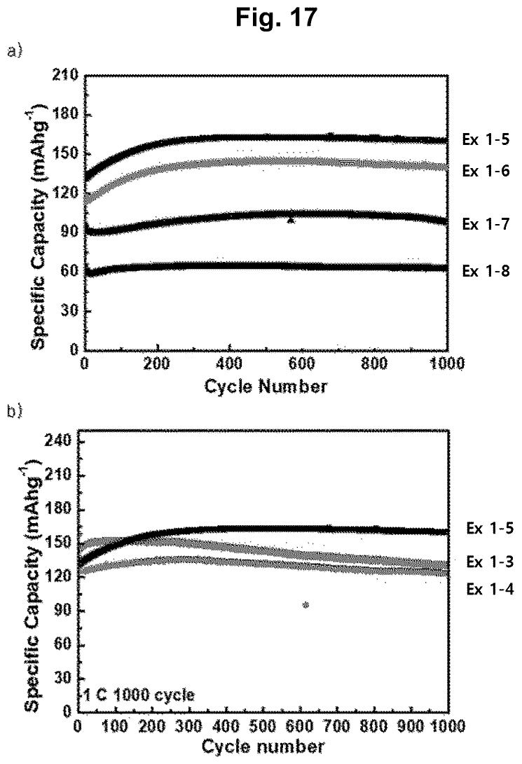

FIG. 17 is a graph of measuring stability for a charge/discharge cycle of lithium secondary half-batteries according to Experimental Examples 1-3 to 1-8 of the present invention.

Referring to FIG. 17, (a) of FIG. 17 showed a measurement of specific capacity for a charge/discharge cycle of the lithium secondary half-batteries according to Experimental Examples 1-5 to 1-8, and (b) of FIG. 17 showed a measurement of specific capacity for a charge/discharge cycle of the lithium secondary batteries according to Experimental Examples 1-5 to 1-8.

As can be understood from FIG. 17, it can be seen that the lithium secondary half-batteries according to Experimental Examples 1-5 to 1-8 have a negative fading property in which the specific capacity increases as the number of charge/discharge cycles increases.

In contrast, it can be seen that the lithium secondary half-batteries according to Experimental Examples 1-3 and 1-4 have a property in which the specific capacity decreases as the number of charge/discharge cycles increases.

It can be understood that the lithium secondary half-batteries according to Experimental Examples 1-5 to 1-8 have a negative fading property because the anode active material in the lithium secondary half-batteries according to Experimental Examples 1-5 to 1-8 is nano-sized TiNbO₄ having tetragonal and rutile crystal structures, the anode active material includes a carbon element, and the anode active material includes pores. Thus, it can be seen that the lithium secondary battery manufactured using the anode active material not only has stability with respect to a charge/discharge cycle but also has a property in which the specific capacity increases as the number of charge/discharge cycles increases.

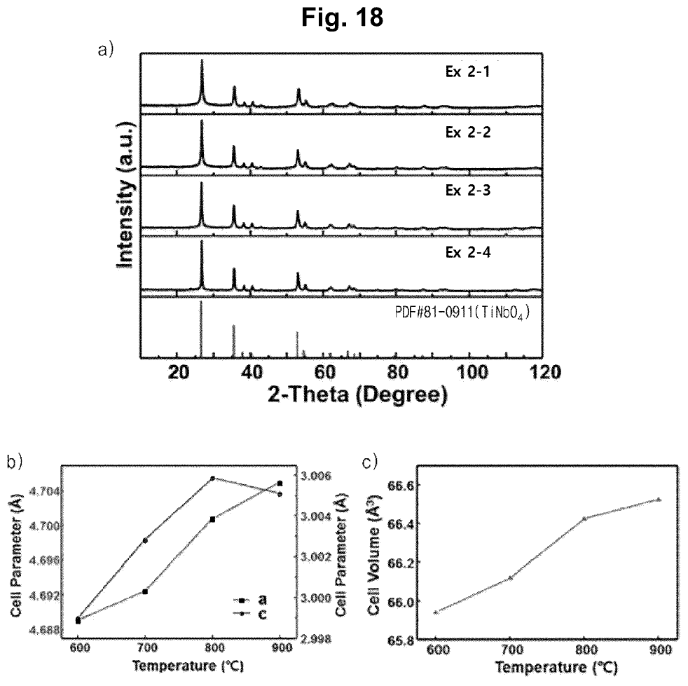

FIG. 18 is a graph analyzing the chemical composition and crystal structure of anode active materials according to Experimental Embodiments 2-1 to 2-4 of the present invention.

Referring to FIG. 18, (a) of FIG. 18 showed an XRD analysis of the chemical composition of the anode active materials according to Experimental Examples 2-1 to 2-4, (b) of FIG. 18 showed a measurement of cell parameter values of the anode active materials according to Experimental Examples 2-1 to 2-4, and (c) of FIG. 18 showed a measurement of cell volume values of the anode active materials according to Experimental Examples 2-1 to 2-4. Then, measurement values related to a crystal structure of the anode active materials according to Experimental Examples 2-1 to 2-4 are summarized as shown in <Table 7> below.

TABLE 7

| | grain | | | | |
|---|---|---|---|---|---|
| | size | cell parameter | | cell volume | |
| Classification | (nm) | α(Å) | c(Å) | (Å) | R_{wp} |
| Experimental | 10.6 | 4.6891 | 2.9990 | 65.941 | 8.644 |
| Example 2-1 | | | | | |
| Experimental | 12.1 | 4.6925 | 3.0028 | 66.120 | 7.418 |
| Example 2-2 | | | | | |
| Experimental | 18.2 | 4.7008 | 3.0059 | 66.423 | 6.835 |
| Example 2-3 | | | | | |
| Experimental | 23.1 | 4.7050 | 3.0051 | 66.523 | 7.294 |
| Example 2-4 | | | | | |

As can be understood from FIG. 18 and <Table 7>, it can be seen that grain size, cell parameter (α), and cell volume values increase in an order of increasing temperature for heat treatment when the anode active materials according to Experimental Examples 2-1 to 2-4 are prepared, that is, in the order of Experimental Examples 2-1, 2-2, 2-3 and 2-4.

Thus, when the anode-active material is prepared, it can be seen that the crystallinity of the anode-active material increases as the temperature for heat treatment increases.

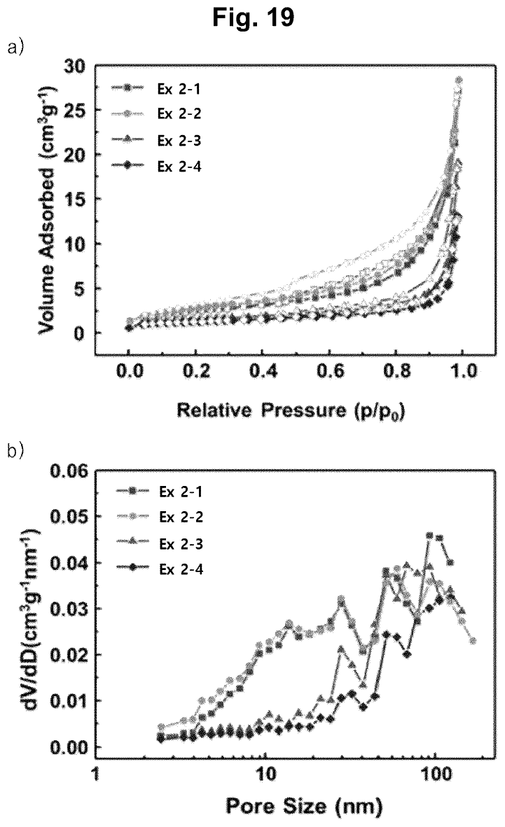

FIG. 19 is a graph analyzing the surface area, pore size, and volume of anode active materials according to Experimental Embodiments 2-1 to 2-4 of the present invention.

Referring to FIG. 19, the surface area, average pore size, and total volume of the anode active materials according to Experimental Examples 2-1 to 2-4 were measured by an adsorption/desorption isotherm of nitrogen gas. The surface area, average pore size, and total volume of the anode active materials were measured as shown in <Table 8> below.

TABLE 8

| | | | Mean pore | Total pore |
|---|---|---|---|---|
| | Temperature of | aₛ BET | diameter | volume |
| Classification | heat treatment | (m²g⁻¹) | (nm) | (cm³g⁻¹) |
| Experimental | 600° C. | 9.0067 | 18.633 | 0.04196 |
| Example 2-1 | | | | |
| Experimental | 700° C. | 9.9196 | 17.691 | 0.04387 |
| Example 2-2 | | | | |
| Experimental | 800° C. | 5.3084 | 22.226 | 0.02950 |
| Example 2-3 | | | | |
| Experimental | 900° C. | 4.3777 | 18.394 | 0.02013 |
| Example 2-4 | | | | |

As can be understood from FIG. 19 and <Table 8>, it can be seen that the surface area and total pore volume of the anode active materials decrease in an order of increasing temperature for heat treatment when the anode active materials according to Experimental Examples 2-1 to 2-4 are prepared, that is, in the order of Experimental Examples 2-1, 2-2, 2-3 and 2-4.

Thus, when the anode active material is prepared, it can be seen that the surface area and total pore volume of the anode active material decreases as the temperature for heat treatment increases.

FIG. 20 is a view showing SEM and TEM pictures of anode active materials according to Experimental Examples 2-1 to 2-4 of the present invention.

Referring to FIG. 20, (a) of FIG. 20 showed an SEM picture of the surface of the particles of the anode active materials according to Experimental Examples 2-1 to 2-4, and (b) of FIG. 20 showed a TEM measurement of a Fourier transform (FFT) pattern for the particles of the anode active materials according to Experimental Examples 2-1 to 2-4.

As can be understood from FIG. 20, it can be seen that the particles of the anode active materials according to Experimental Examples 2-1 to 2-4 have a bulk form.

Then, according to FFT analysis of TEM, it can be confirmed that an FFT pattern of the particles of the anode active materials according to Experimental Examples 2-1 to 2-4 coincide with a pattern of the TiNbO₄ crystal plane.

Thus, it can be seen that the anode active materials according to Experimental Examples 2-1 to 2-4 have particles in the form of bulk having a crystal structure of TiNbO₄.

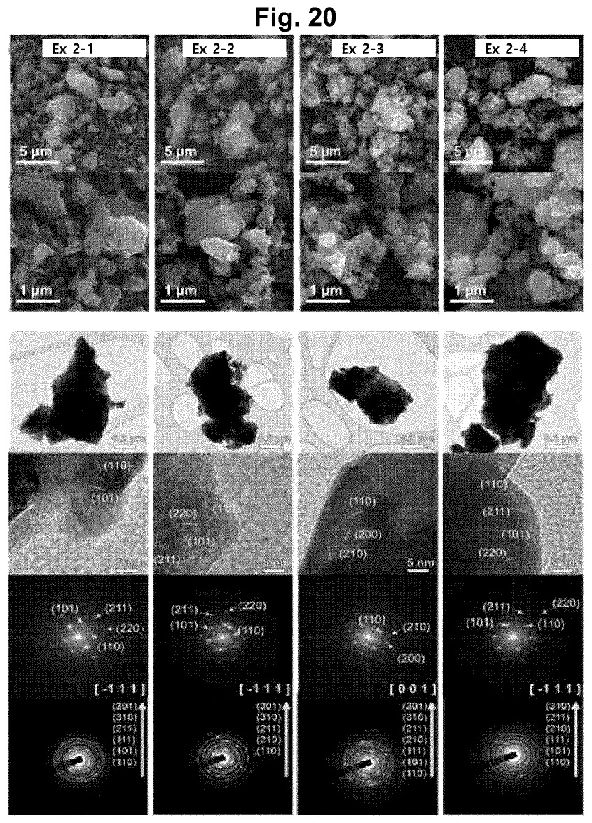

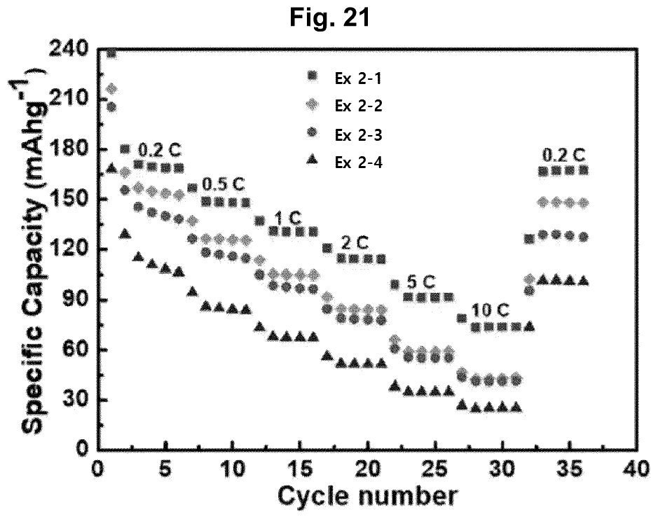

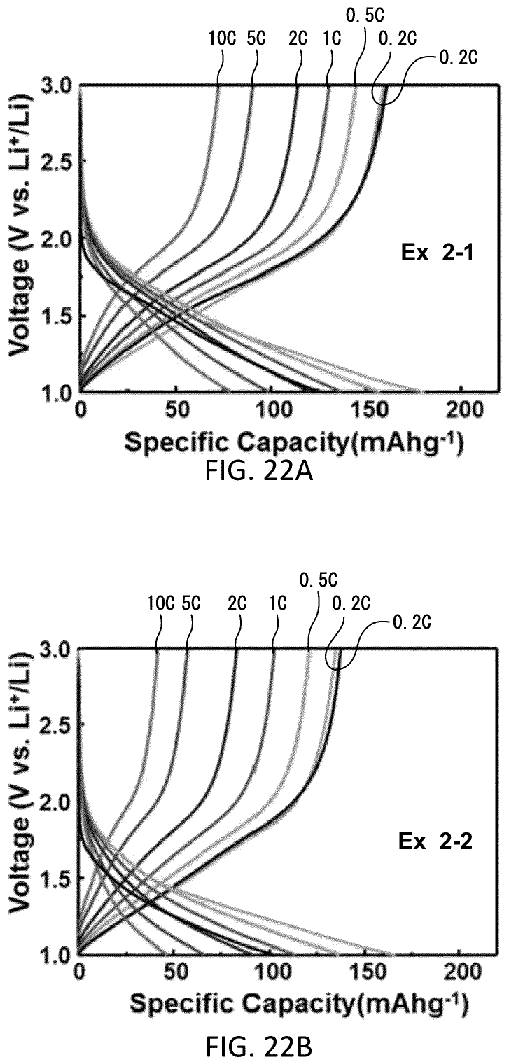

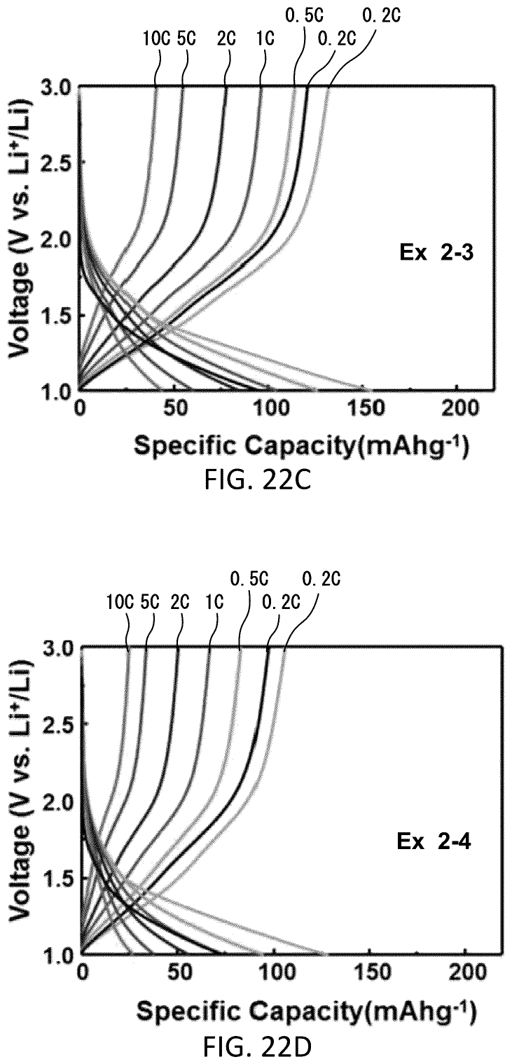

FIG. 21 is a graph of measuring a specific capacity value for each C-rate during charging/discharging of lithium secondary half-batteries according to Experimental Examples 2-1 to 2-4 of the present invention, and FIGS. 22A through 22D are graphs of measuring a voltage change value according to a specific capacity for each C-rate of lithium secondary half-batteries according to Experimental Examples 2-1 to 2-4 of the present invention.

Referring to FIG. 21, the lithium secondary half-batteries according to Experimental Examples 2-1 to 2-4 were provided with a current density of 0.1 C and subjected to charge/discharge once to form an SEI, and then the lithium secondary half-batteries were provided with a current density of 0.2 C to 10 C and subjected to charge/discharge five times for each C-rate to measure a specific capacity value. A specific capacity value for each C-rate of the lithium secondary half-batteries according to Experimental Examples 2-1 to 2-4 are summarized as shown in <Table 9> below.

TABLE 9

| | 0.1 C | 0.2 C | 0.5 C | 1.0 C | 5.0 C | 10.0 C |
|---|---|---|---|---|---|---|
| Classification | (mAhg⁻¹) | (mAhg⁻¹) | (mAhg⁻¹) | (mAhg⁻¹) | (mAhg⁻¹) | (mAhg⁻¹) |
| Experimental | 237.7 | 180.3 | 156.8 | 137.1 | 99.0 | 79.0 |
| Example 2-1 | | | | | | |
| Experimental | 216.4 | 166.5 | 137.1 | 113.6 | 66.4 | 46.6 |
| Example 2-2 | | | | | | |
| Experimental | 205.3 | 155.4 | 126.4 | 104.9 | 60.8 | 43.8 |
| Example 2-3 | | | | | | |
| Experimental | 168.3 | 128.8 | 94.6 | 73.6 | 38.1 | 26.9 |
| Example 2-4 | | | | | | |

Referring to FIGS. 22A through 22D, the lithium secondary half-batteries according to Experimental Examples 2-1 to 2-4 were provided with a current density of 0.2 C to 10 C as a galvanostatic charge and discharge profile, and a change in a voltage value according to specific capacity was measured at the time of one charge/discharge.

As can be understood from FIG. 21 and <Table 9>, it can be seen that the lithium secondary half-battery according to Experimental Example 2-1 has the highest specific capacity value in all C-rates (0.2 C to 10 C). Then, it can be seen that a specific capacity value at 0.2 C to 10 C decreases in an order of increasing a temperature for heat treatment when the anode active materials in the lithium secondary half-battery are prepared, that is, in the order of Experimental Examples 2-1, 2-2, 2-3 and 2-4.

In addition, it can be seen that the lithium half-batteries according to experimental examples (Experimental Examples 2-1 to 2-4) have substantially the same specific capacity value measured at initial 0.2 C and specific capacity value measured at later 0.2 C. Thus, it can be seen that the anode active material in the lithium half-battery has a stable structure in which the intercalation and deintercalation of lithium ions easily occur during charging and discharging of the lithium half-batteries according to the experimental examples.

Then, as can be understood from FIGS. 22A through 22D, it can be seen that the anode active materials according to Experimental Examples 2-1 to 2-4 have a single phase depending on the distribution of voltage values according to a specific capacity for each C-rate during charging and discharging of the lithium secondary half-batteries according to experimental examples.

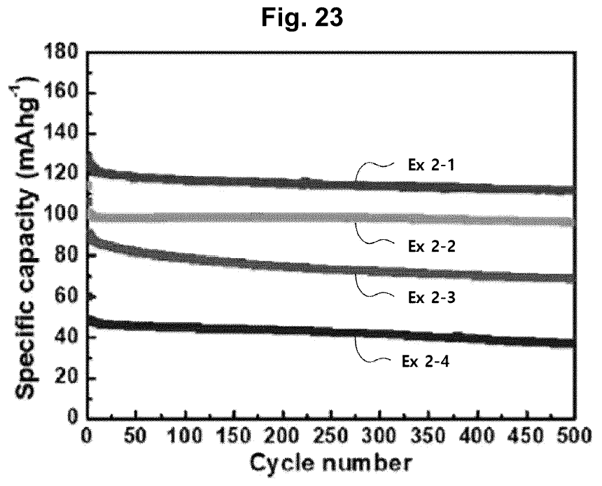

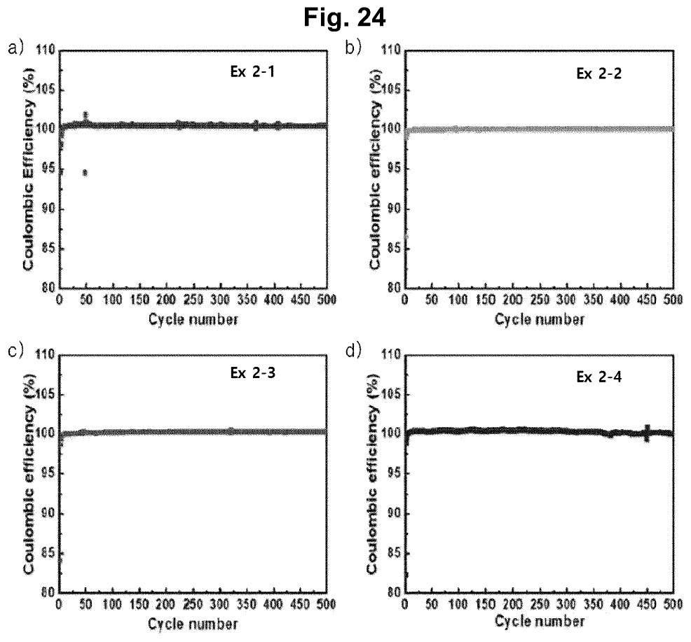

FIG. 23 is a graph measuring stability for a charge/discharge cycle of lithium secondary half-batteries according to Experimental Examples 2-1 to 2-4 of the present invention, and FIG. 24 is a graph measuring Coulombic efficiency (CE) values of lithium secondary half-batteries according to Experimental Examples 2-1 to 2-4 of the present invention.

Referring to FIG. 23, a specific capacity for a charge/discharge cycle of the lithium secondary half-batteries according to Experimental Examples 2-1 to 2-4 was measured. Referring to FIG. 24, a CE value for a charge/discharge cycle of the lithium secondary batteries according to Experimental Examples 2-1 to 2-4 was measured.

As can be understood from FIG. 23, it can be seen that the lithium secondary half-batteries according to Experimental Examples 2-1 to 2-4 have a small difference between a specific capacity value at which 500 cycles of charge and discharge are performed and a specific capacity value at which 100 cycles of charge and discharge are performed. Accordingly, it can be seen that the lithium secondary half-batteries according to experimental examples (Experimental Examples 2-1 to 2-4) have stability for 500 charge/discharge cycles.

Then, as can be understood from FIG. 24, it can be seen that a recovery rate of a CE value decreases in an order of increasing a temperature for heat treatment when the anode active materials according to Experimental Examples 2-1 to 2-4 are prepared, that is, in the order of Experimental Examples 2-1, 2-2, 2-3 and 2-4, when the lithium secondary half-batteries according to experimental examples are subjected to 1 to 100 charge/discharge cycles. In addition, it can be seen that the lithium secondary half-batteries according to the experimental examples maintain a CE value substantially close to 100% when a charge/discharge is performed up to 500 cycles after performing 100 charge/discharge cycles.

Thus, it can be seen that the lithium secondary half-battery has stability and high efficiency for a charge/discharge cycle for a long period of time due to the anode active material.

Although the present invention has been described in detail with reference to exemplary embodiments, the scope of the present invention is not limited to a specific embodiment and should be interpreted by the attached claims. In addition, those skilled in the art should understand that many modifications and variations are possible without departing from the scope of the present invention.

A technical idea according to an embodiment of the present application can be used as an anode active material for a lithium secondary battery, and the lithium secondary battery including the same can be utilized in various industrial fields such as a mobile device, an electric vehicle, an ESS, and the like.

1. A method for preparing an anode active material, the method comprising:
preparing a first transition metal oxide source and a second transition metal oxide source;
providing the first transition metal oxide source and the second transition metal oxide source for a secondary alcohol to prepare a base source;
providing a hydrolysis catalyst for the base source and inducing a sol-gel reaction to prepare a transition metal oxide precursor; and
subjecting the transition metal oxide precursor to heat treatment in a nitrogen environment to prepare an anode-active material containing a transition metal oxide.

2. The method of claim 1, wherein the transition metal oxide precursor is subjected to heat treatment at a temperature higher than 550° C.

3. The method of claim 1, wherein surface roughness, crystallinity, carbon atom content, and pore size of particles of the anode active material being generated are controlled by a temperature at which the transition metal oxide precursor is subjected to heat treatment.

4. The method of claim 1, wherein the hydrolysis catalyst is acetone, in which distilled water is further provided to the acetone and thus a sol-gel reaction of the base source is induced by the distilled water.

5. The method of claim 1, wherein the secondary alcohol is any one of ethylene glycol, diethylene glycol, or triethylene glycol, in which a size of particles of the anode active material is controlled to a nano-size by the secondary alcohol and a carbon atom is provided on a surface and an inside of the particles of the anode active material.

6. The method of claim 1, wherein:
the first transition metal oxide source is titanium butoxide, and
the second transition metal oxide source is niobium ethoxide.

7. A lithium secondary battery comprising:
an anode electrode including the anode active material according to claim 6;
a cathode electrode disposed on the anode electrode and including lithium; and
an electrolyte between the anode electrode and the cathode electrode,
wherein a battery has a negative fading property in which a capacity of the battery increases as a number of charge/discharge cycles increases during charging/discharging.

8. A method for preparing an anode electrode, the method comprising:
preparing an anode active material according to the method for preparing the anode active material according to claim 1;
stirring the anode active material and a polymer binder to prepare a slurry; and
coating the slurry on a current collector to prepare an anode electrode.

9. An anode active material comprising:
a nano-sized particle in which two transition metal atoms and an oxygen atom have tetragonal and rutile crystal structures,
in which a carbon atom is provided on a surface and an inside of the particle and a pore is provided in the particle.

10. The anode active material of claim 9, wherein:
the transition metal atoms are Ti and Nb, and
a chemical composition of the particle is TiNbO₄.

11. The anode active material of claim 10, wherein a size of the particle is 200 nm to 300 nm.

12. A method for preparing an anode active material, wherein:
a surface roughness of particles of an anode active material being generated increases as a temperature for heat treatment of a transition metal oxide precursor increases;
a grain size of the particles of the anode active material being generated increases and thus crystallinity of the particles of the anode active material increases, as the temperature for heat treatment of the transition metal oxide precursor increases;
a carbon atom content of the particles of the anode active material being generated decreases as the temperature for heat treatment of the transition metal oxide precursor increases; and
a pore size of the particles of the anode active material being generated increases as the temperature for heat treatment of the transition metal oxide precursor increases.

13. The method of claim 12, wherein an oxygen vacancy decreases due to a decrease in a carbon atom content of the particles of the anode active material being generated as the temperature for heat treatment of the transition metal oxide precursor increases.
